(19) United States
(12) Patent Application Publication
(10) Pub. No.: US 2011/0320954 A1
(43) Pub. Date: Dec. 29, 2011

(54) RELATED WEB FEED CORRELATION WITH DYNAMIC CONTENT ACCESS

(75) Inventors: Craig M. Lawton, Raleigh, NC (US); Paul F. McMahan, Apex, NC (US); Douglas B. Mueller, Apex, NC (US); John P. Whitfield, Cary, NC (US)

(73) Assignee: INTERNATIONAL BUSINESS MACHINES CORPORATION, Armonk, NY (US)

(21) Appl. No.: 12/824,770

(22) Filed: Jun. 28, 2010

(51) Int. Cl. G06F 3/048; G06F 15/16

(52) U.S. Cl. 715/739; 715/738

(57) ABSTRACT

At least one element of received first feed content of a first feed is determined by a computer client device to include a first feed correlation identifier. The first feed correlation identifier identifies a portion of a second feed associated with the at least one element of the received first feed content. The received first feed content is displayed with a first selectable user interface element associated with the at least one element of the received first feed content determined to include the first feed correlation identifier. A selection of the first selectable user interface element is detected. In response to detecting the selection of the first selectable user interface element, a feed server is queried for the portion of the second feed identified by the first feed correlation identifier.

### BACKGROUND

The present invention relates to composing and correlating information about related resources across multiple syndicated feeds. More particularly, the present invention relates to related web feed correlation with dynamic content access.

Web syndication is a form of content syndication by which website content is made available to multiple other sites and devices. Web syndication may be accomplished using web feeds. Web feeds are made available from a website and may be delivered to computing devices. The web feeds provide a summary of the website's recently-added website content. News and forum posts are examples of website content available via web feeds.

### BRIEF SUMMARY

A method includes determining, via a computer client device, that at least one element of received first feed content of a first feed comprises a first feed correlation identifier that identifies a portion of a second feed associated with the at least one element of the received first feed content; displaying the received first feed content with a first selectable user interface element associated with the at least one element of the received first feed content determined to comprise the first feed correlation identifier; detecting a selection of the first selectable user interface element; and querying, in response to detecting the selection of the first selectable user interface element, a feed server for the portion of the second feed identified by the first feed correlation identifier.

A system includes a display; an input device; and a processor programmed to determine that at least one element of received first feed content of a first feed comprises a first feed correlation identifier that identifies a portion of a second feed associated with the at least one element of the received first feed content; display the received first feed content with a first selectable user interface element associated with the at least one element of the received first feed content determined to comprise the first feed correlation identifier via the display; detect a selection of the first selectable user interface element via the input device; and query, in response to detecting the selection of the first selectable user interface element via the input device, a feed server for the portion of the second feed identified by the first feed correlation identifier.

A computer program product includes a computer readable storage medium including a computer readable program code, where the computer readable program code when executed on a computer causes the computer to determine, via a computer client device, that at least one element of received first feed content of a first feed comprises a first feed correlation identifier that identifies a portion of a second feed associated with the at least one element of the received first feed content; display the received first feed content with a first selectable user interface element associated with the at least one element of the received first feed content determined to comprise the first feed correlation identifier; detect a selection of the first selectable user interface element; and query, in response to detecting the selection of the first selectable user interface element, a feed server for the portion of the second feed identified by the first feed correlation identifier.

### BRIEF DESCRIPTION OF THE SEVERAL VIEWS OF THE DRAWINGS

FIG. 1 is a block diagram of an example of an implementation of a system for related web feed correlation with dynamic content access according to an embodiment of the present subject matter;

FIG. 2 is a block diagram of an example of an implementation of a client computing device capable of performing related web feed correlation with dynamic content access according to an embodiment of the present subject matter;

FIG. 3 is a flow chart of an example of an implementation of a process for related web feed correlation with dynamic content access according to an embodiment of the present subject matter;

FIG. 4 is a flow chart of an example of an implementation of a process for iterative related web feed correlation with dynamic content access according to an embodiment of the present subject matter;

FIG. 5A is an illustration of an example of an implementation of a graphical user interface pane, including a hierarchical list view of elements, that may be used to implement the related web feed correlation with dynamic content access according to an embodiment of the present subject matter; and

FIG. 5B is an illustration of an example of an implementation of a graphical user interface pane, including updates to a hierarchical list view of elements received in response to a dynamic query, that may be used to implement the related web feed correlation with dynamic content access according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides related web feed correlation with dynamic content access. Related web feed content is correlated for dynamic retrieval in response to detection of user input indicating interest in accessing the correlated related web feed content. A feed correlation identifier associated with a content element within a first web feed references content that is identified within a second web feed via the same feed correlation identifier. The feed correlation identifier may identify all or a portion of the content within the second web feed. For purposes of the present description, a “portion” of a related web feed may include some or all of the content of the related web feed. In response to accessing the first feed, a determination is made as to whether a feed correlation identifier is associated with any content elements within the first feed. A selectable user interface element is displayed in association with each content element determined to have an associated feed correlation identifier. In response to detecting a selection of one of the selectable user interface elements, a feed server is dynamically queried for the respective portion of the content of the second web feed identified by the feed correlation identifier.

Though the present description primarily utilizes “displaying” user interface elements and feed content, it should be noted that the present subject matter is not limited to visual user interfaces. In particular, “accessible” user interfaces that include audible information (e.g., feed content), queues, prompts, and input processing may also be processed in accordance with the present subject matter. As such, accessible and other user interfaces are considered within the scope of the present subject matter.

The dynamic query for related portions of related web feeds reduces bandwidth requirements by retrieving content from related web feeds in response to specific requests rather than retrieving related web feed content that may not be requested. Bandwidth requirements may be further reduced by dynamically querying for and retrieving specifically-identified portions of related web feeds rather than retrieving entire related web feeds.

A feed correlation identifier may be syntactically added to web feed content. The web feed content syntax may include, for example, really simple syndication (RSS) extensible markup language (XML) syntax or asynchronous Javascript® and XML syntax (AJAX). The feed correlation identifiers may include, for example, an XML path language (XPath) directive associated with each content element of a feed that is related to at least a portion of another feed.

A syntax tag pair may be used within web feed content syntax to reference content in a related web feed. The syntax tag pair may encapsulate a related feed content identifier that identifies the related content or content element(s) within the related web feed. The respective feed correlation identifier may include a syntax tag pair and the encapsulated content identifier. Examples of feed correlation identifiers based upon syntax tag pairs that encapsulate a reference to related feed content include syntax tag pairs such as a “uses” tag pair (e.g., <uses>related feed content identifier</uses>), a “references” tag pair (e.g., <references>related feed content identifier</references>), or other syntax tag pairs as appropriate for a given syntax and implementation.

A different syntax tag pair may be used within the related web feed content syntax to identify the related content or portion thereof within the related web feed. The syntax tag pair used to identify the related content or portion thereof may encapsulate the respective related feed content identifier that identifies the related content or content element(s) within the correlated related web feed. Examples of feed correlation identifiers based upon syntax tag pairs that encapsulate a reference to related feed content include syntax tag pairs such as a “usedBy” tag pair (e.g., <usedBy>related feed content identifier</usedBy>), a “referenced” tag pair (e.g., <referenced>related feed content identifier</referenced>), or other syntax tag pairs as appropriate for a given syntax and implementation.

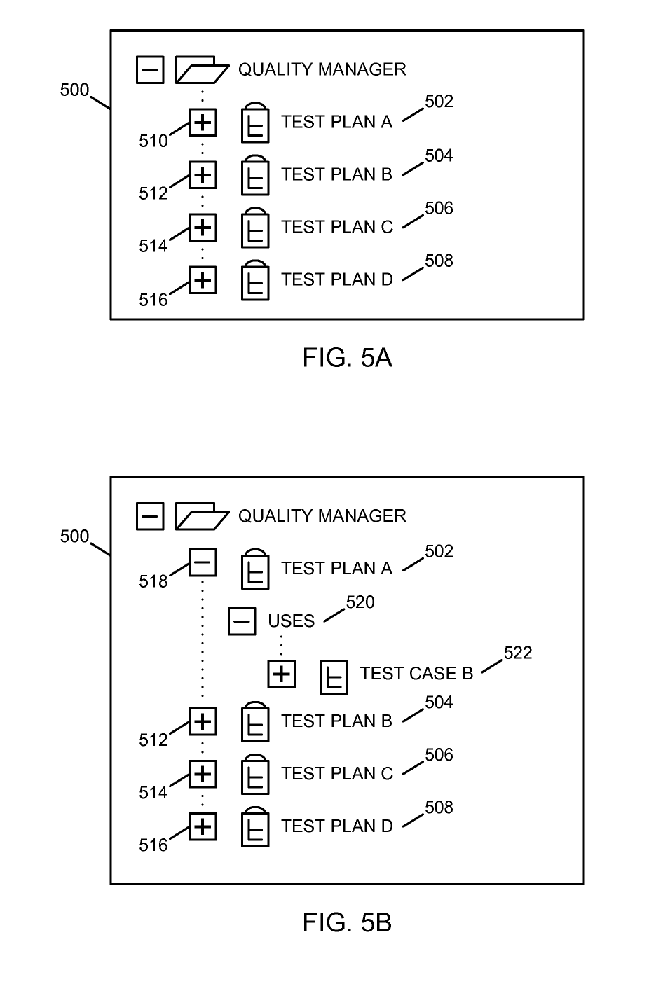

A detailed example of use of feed correlation identifiers based upon syntax tag pairs is described in detail below in association with FIGS. 5A and 5B. Pseudo code examples of feed content that include the syntax tag pairs that implement the feed correlation identifiers within the example are also provided.

Correlation of related web feed content may be accomplished, for example, by displaying a hierarchical list view of content elements received in association with a first web feed. In such an example, a displayed selectable user interface element may include any visual identifier or icon that is selectable via a user interface device, such as a mouse or keyboard. For example, a selectable user interface element may include a plus (e.g., “+”) symbol or other symbol associated with the displayed content element that references the correlated related portion of content in the related web feed. In such an example, the displayed plus (e.g., “+”) symbol may be considered a list expansion icon.

In response to selection of the associated selectable user interface element, a dynamic query of the web feed server associated with the correlated related web feed may be issued to retrieve the related portion of the correlated related web feed. In response to receipt of the related portion of the related web feed, the received portion of the related feed may be displayed in association with the location of the selectable user interface element. As one possible example, a hierarchical implementation may be used to display content elements from a first web feed. The selectable user interface element (described above as a plus symbol) may be changed to show that the query has been completed. One example of a changed selectable user interface element includes a minus (e.g., “−”) symbol. In such an example, the displayed minus (e.g., “−”) symbol may be considered a list collapse icon.

The selectable list collapse icon may replace the selectable list expansion icon and be displayed in association with an element of received first feed content that references the related feed content within the hierarchical list view. The hierarchical list view of the received first feed content may be expanded and a hierarchical expansion list view of the portion of a second feed content may be displayed in association with the content element of the received first feed content within the hierarchical list view. Display of the hierarchical expansion list view may be terminated (e.g., collapsed) in response to detection of a selection of the selectable list collapse icon.

As such, the related web feed correlation with dynamic content access described herein provides a user-friendly dynamic query for related portions of correlated related web feeds. Bandwidth requirements are reduced, as described above, by retrieving content from related web feeds in response to specific requests rather than retrieving related web feed content that may not be requested. Bandwidth requirements may be further reduced by dynamically querying for and retrieving specifically-identified portions of related web feeds rather than retrieving entire related web feeds.

It should be noted that the present subject matter is described in association with content feeds. However, it is additionally understood that the use of content feeds is for description purposes and that other related types of resources or feeds may be processed in association with the present subject matter as described herein. For example, other types of resources and feeds that may utilize the present subject matter include photos, blogs, calendars, wikis, and other resources or content types.

The related web feed correlation with dynamic content access described herein may be performed in real time to allow prompt dynamic querying of related web feeds. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

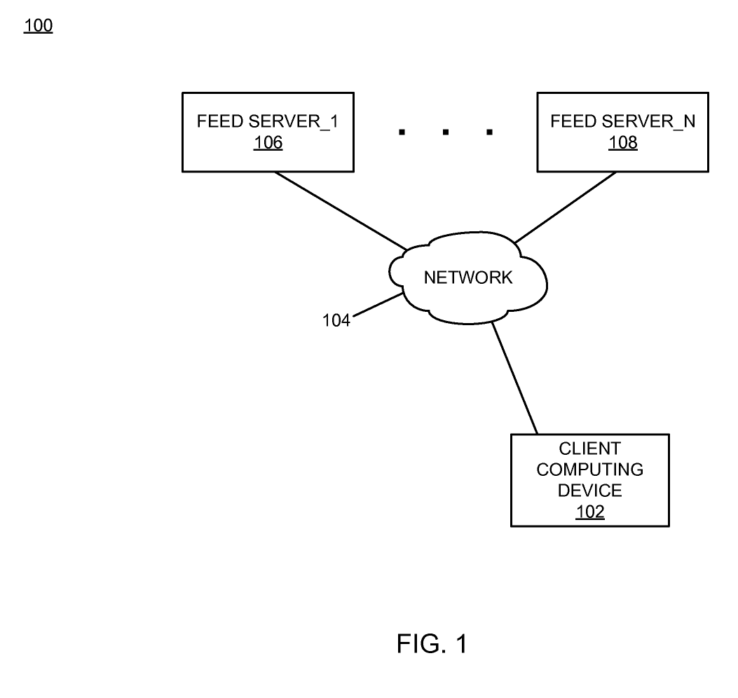

FIG. 1 is a block diagram of an example of an implementation of a system 100 for related web feed correlation with dynamic content access. A client computing device 102 communicates via a network 104 with a feed server_1106 through a feed server_N 108.

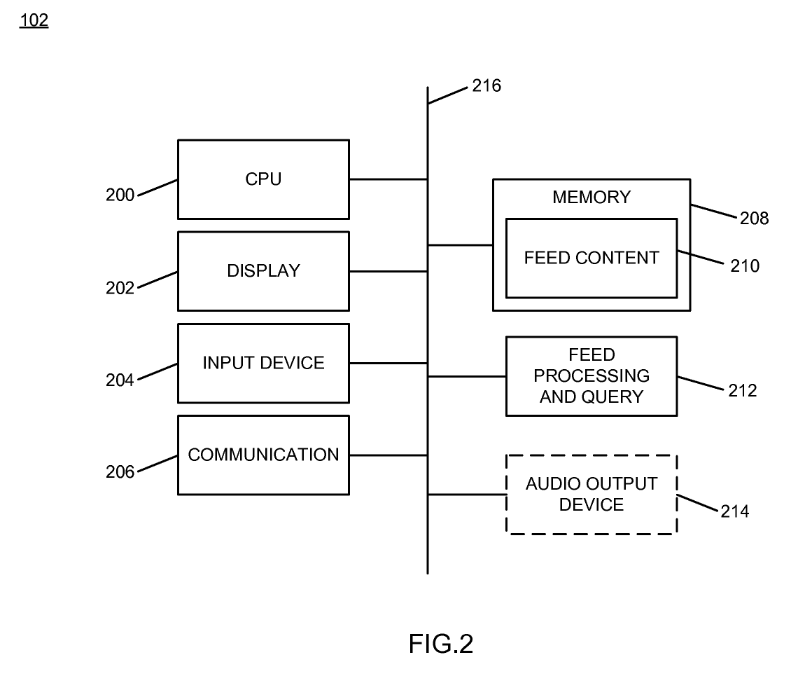

As will be described in more detail below in association with FIG. 2 through FIG. 5B, the client computing device 102 provides related web feed correlation with dynamic content access. The related web feed correlation with dynamic content access is based upon relationships between content elements within the related web feeds. The related web feed correlation with dynamic content access utilizes feed correlation identifiers to establish, reference, and access related portions of content in related feeds dynamically in response to detection of a selection of a selectable user interface element.

It should be noted that the client computing device 102 may be a portable computing device, either by a user's ability to move the client computing device 102 to different locations, or by the client computing device 102's association with a portable platform, such as a plane, train, automobile, or other moving vehicle. It should also be noted that the client computing device 102 may be any computing device capable of processing information as described above and in more detail below. For example, the client computing device 102 may include devices such as a personal computer (e.g., desktop, laptop, palm, etc.) or a handheld device (e.g., cellular telephone, personal digital assistant (PDA), email device, music recording or playback device, etc.), or any other device capable of processing information, such as web feeds, as described in more detail below.

The network 104 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The feed server_1106 through the feed server_N 108 include any computing device capable of providing syndicated feed content or other related resources. As such, the feed server_1106 may provide access to a first feed, while the feed server_N 108 may provide access to a second related feed. Alternatively, any of the feed server_1106 through the feed server_N 108 may store and provide access to multiple related feeds. Many variations for storage and access provisions to related feeds and resources are possible and all are considered within the scope of the present subject matter.

FIG. 2 is a block diagram of an example of an implementation of the client computing device 102 capable of performing related web feed correlation with dynamic content access. A central processing unit (CPU) 200 provides computer instruction execution, computation, and other capabilities within the client computing device 102. A display 202 provides visual information to a user of the client computing device 102 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202. The input device 204 may further include an audio input device capable of receiving and processing “accessible” user interface commands.

A communication module 206 provides interconnection capabilities that allow the client computing device 102 to communicate with other modules within the system 100, such as the feed server_1106 through the feed server_N 108, to dynamically correlate and provide dynamic content access to multiple related web feeds and resources. The communication module 206 may include any electrical, protocol, and protocol conversion capabilities useable to provide the interconnection capabilities. Though the communication module 206 is illustrated as a component-level module for ease of illustration and description purposes, it should be noted that the communication module 206 may include any hardware, programmed processor(s), and memory used to carry out the functions of the communication module 206 as described above and in more detail below. For example, the communication module 206 may include additional controller circuitry in the form of application specific integrated circuits (ASICs), processors, antennas, and/or discrete integrated circuits and components for performing communication and electrical control activities associated with the communication module 206. Additionally, the communication module 206 may include interrupt-level, stack-level, and application-level modules as appropriate. Furthermore, the communication module 206 may include any memory components used for storage, execution, and data processing for performing processing activities associated with the communication module 206. The communication module 206 may also form a portion of other circuitry described without departure from the scope of the present subject matter.

A memory 208 includes a feed content storage area 210 that stores feed content in association with the client computing device 102. As will be described in more detail below, feed content stored within the feed content storage area 210 is used to correlate and provide dynamic content access to multiple related web feeds and resources.

It is understood that the memory 208 may include any combination of volatile and non-volatile memory suitable for the intended purpose, distributed or localized as appropriate, and may include other memory segments not illustrated within the present example for ease of illustration purposes. For example, the memory 208 may include a code storage area, a code execution area, and a data area without departure from the scope of the present subject matter.

A feed processing and query module 212 is also illustrated. The feed processing and query module 212 provides feed processing and feed server query processing for the client computing device 102, as described above and in more detail below. The feed processing and query module 212 implements the related web feed correlation with dynamic content access of the client computing device 102.

Though the feed processing and query module 212 is illustrated as a component-level module for ease of illustration and description purposes, it should be noted that the feed processing and query module 212 may include any hardware, programmed processor(s), and memory used to carry out the functions of this module as described above and in more detail below. For example, the feed processing and query module 212 may include additional controller circuitry in the form of application specific integrated circuits (ASICs), processors, and/or discrete integrated circuits and components for performing communication and electrical control activities associated with the respective devices. Additionally, the feed processing and query module 212 may also include interrupt-level, stack-level, and application-level modules as appropriate. Furthermore, the feed processing and query module 212 may include any memory components used for storage, execution, and data processing for performing processing activities associated with the module.

It should also be noted that the feed processing and query module 212 may form a portion of other circuitry described without departure from the scope of the present subject matter. Further, the feed processing and query module 212 may alternatively be implemented as an application stored within the memory 208. In such an implementation, the feed processing and query module 212 may include instructions executed by the CPU 200 for performing the functionality described herein. The CPU 200 may execute these instructions to provide the processing capabilities described above and in more detail below for the client computing device 102. The feed processing and query module 212 may form a portion of an interrupt service routine (ISR), a portion of an operating system, a portion of a browser application, or a portion of a separate application without departure from the scope of the present subject matter.

An audio output device 214 provides audio output capabilities for the client computing device 102. The audio output device 214 may be utilized, for example, for outputting audible information (e.g., feed content), queues, and prompts for accessible implementations of the present subject matter. The audio output device 214 is illustrated in a dashed-line configuration to show that it may be considered optional as appropriate for a given implementation. Additionally, though not depicted as optional, it is understood that the display 202 may be omitted within an accessible implementation without departure from the scope of the present subject matter.

The CPU 200, the display 202, the input device 204, the communication module 206, the memory 208, the feed processing and query module 212, and the audio output device 214 are interconnected via an interconnection 216. The interconnection 216 may include a system bus, a network, or any other interconnection capable of providing the respective components with suitable interconnection for the respective purpose.

While the client computing device 102 is illustrated with and has certain components described, other modules and components may be associated with the client computing device 102 without departure from the scope of the present subject matter. Additionally, it should be noted that, while the client computing device 102 is described as a single device for ease of illustration purposes, the components within the client computing device 102 may be co-located or distributed and interconnected via a network without departure from the scope of the present subject matter. For a distributed arrangement, the display 202 and the input device 204 may be located at a point of sale device, kiosk, or other location, while the CPU 200 and memory 208 may be located at a local or remote server. Many other possible arrangements for components of the client computing device 102 are possible and all are considered within the scope of the present subject matter. Accordingly, the client computing device 102 may take many forms and may be associated with many platforms.

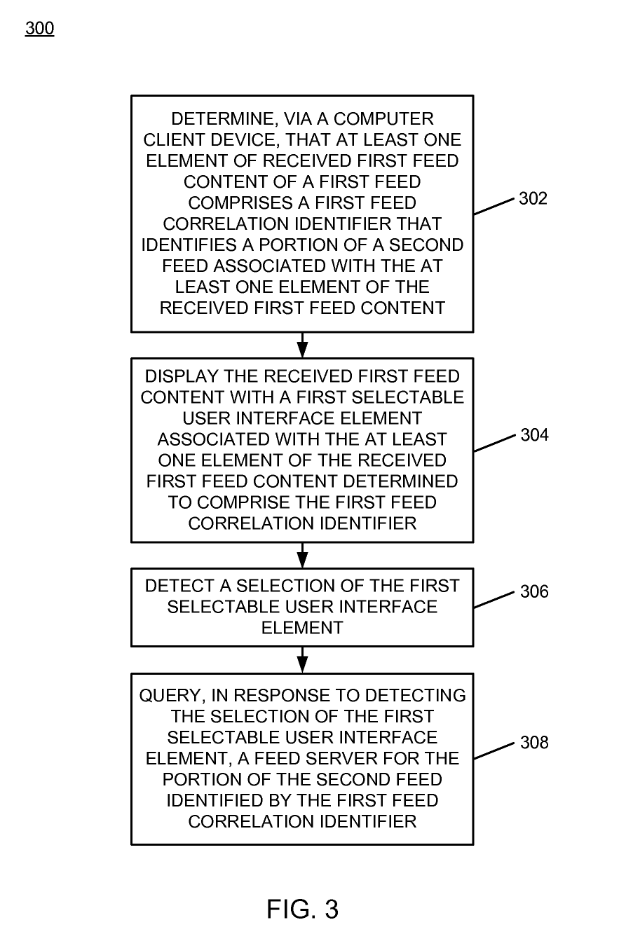

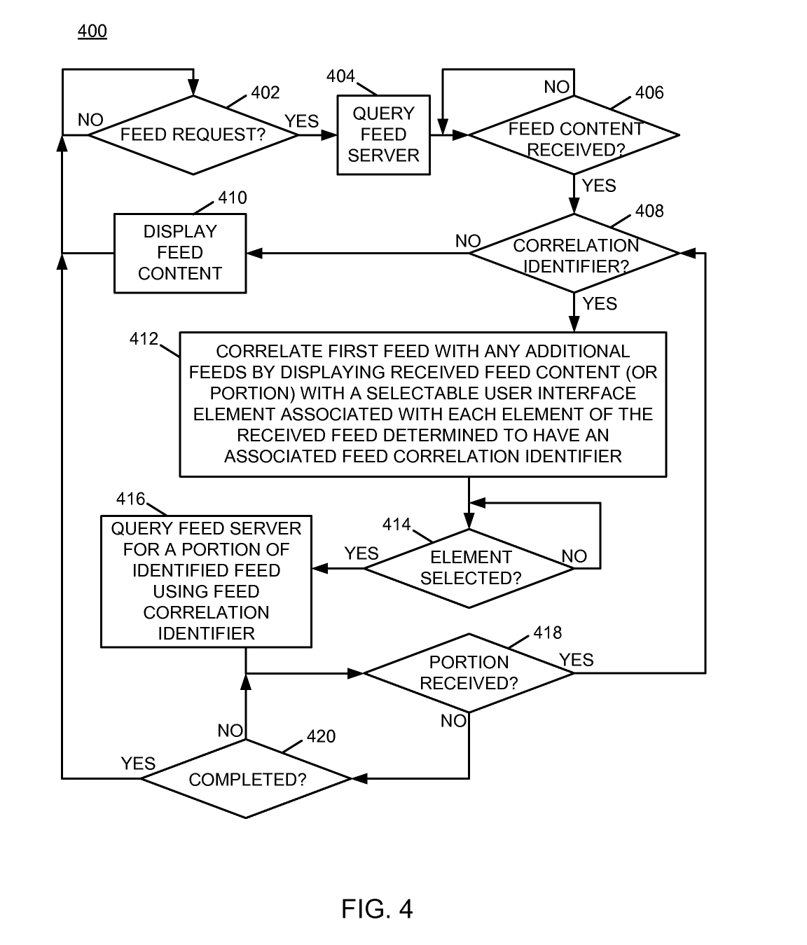

FIG. 3 through FIG. 4 below describe example processes that may be executed by devices, such as the client computing device 102, to perform the related web feed correlation with dynamic content access associated with the present subject matter. Many other variations on the example processes are possible and all are considered within the scope of the present subject matter. The example processes may be performed by modules, such as the feed processing and query module 212 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for related web feed correlation with dynamic content access. At block 302, the process 300 determines, via a computer client device, that at least one element of received first feed content of a first feed comprises a first feed correlation identifier that identifies a portion of a second feed associated with the at least one element of the received first feed content. At block 304, the process 300 displays the received first feed content with a first selectable user interface element associated with the at least one element of the received first feed content determined to comprise the first feed correlation identifier. At block 306, the process 300 detects a selection of the first selectable user interface element. At block 308, the process 300 queries, in response to detecting the selection of the first selectable user interface element, a feed server for the portion of the second feed identified by the first feed correlation identifier.

FIG. 4 is a flow chart of an example of an implementation of a process 400 for iterative related web feed correlation with dynamic content access. At decision point 402, the process 400 makes a determination as to whether a feed request has been received or detected. A feed request may be received or detected, for example, via a user input device such as the input device 204, a browser access of a web feed, or other event as appropriate for a given implementation.

In response to determining that a feed request has been received or detected, the process 400 queries a feed server, such as one of the feed server_1106 through the feed server_N 108, for the requested web feed at block 404. At decision point 406, the process 400 makes a determination as to whether feed content associated with the requested feed has been received. In response to determining that requested feed content has been received, the process 400 makes a determination at decision point 408 as to whether at least one element of received feed content includes a feed correlation identifier that identifies a portion of a second feed associated with at least one element of the first received feed content.

In response to determining that a feed correlation identifier is not associated with any content element within the first received feed at decision point 408, the process 400 displays the feed content at block 410 and returns to decision point 402 to await an additional feed request. In response to determining that at least one feed correlation identifier is associated with at least one content element within the first received feed at decision point 408, the process 400 correlates the first feed with any additional feeds by displaying the received feed content with a selectable user interface element associated with each element of the received feed determined to have an associated feed correlation identifier at block 412.

As described above, a user may select a displayed selectable user interface element and, in response to detection of such a selection, the process 400 may dynamically query a feed server, such as one of the feed server_1106 through the feed server_N 108, for a portion of a related feed that has been correlated with the content element of the first feed with which the selectable user interface element is associated. As such, in subsequent iterations of processing within the process 400, the process 400 may receive a portion of feed content associated with a related web feed at block 412.

At decision point 414, the process 400 makes a determination as to whether selection of a selectable user interface element has been detected. In response to determining that selection of a selectable user interface element has been detected, the process 400 queries a feed server associated with a related feed identified by the associated feed correlation identifier for a portion of the identified feed using the feed correlation identifier at block 416. It should be understood that the feed server that is queried for the related feed content may be the same feed server or a different feed server without departure from the scope of the present subject matter.

At decision point 418, the process 400 makes a determination as to whether the requested portion of the identified feed has been received. In response to determining that the portion of the identified feed has not been received, the process 400 makes a determination at decision point 420 as to whether processing of dynamic queries for related feed content has been completed. In response to determining that processing of dynamic queries for related feed content has not been completed at decision point 420, the process 400 returns to decision point 418 to determine whether the portion of the identified feed has been received.

In response to determining that the portion of the identified feed has been received at decision point 418, the process 400 returns to decision point 408 to make a determination as to whether a feed correlation identifier is associated with any content element in the portion of the identified feed content that was received. As such, the process 400 iterates as described above to correlate additional related feeds that are related to content elements of received feeds, or portions thereof, and nests related feed content within a displayed graphical user interface, such as the graphical user interface pane 500 described in FIGS. 5A and 5B below. Accordingly, the process 400 iteratively correlates multiple related web feeds. Returning to the description of decision point 420, in response to determining that processing for dynamic queries for related feeds is completed, the process 400 returns to decision point 402 to await a new feed request.

As such, the process 400 receives first feed content of a first feed and determines whether a feed correlation identifier is associated with any element(s) in the first feed. The process 400 correlates the first feed with any additional related feeds identified and associated with any content elements in the first feed using the feed correlation identifier. In response to selection of displayed selectable user interface elements, the process 400 dynamically queries the associated related web feed for an identified portion of web feed content of the associated second web feed. This processing may continue for additional related web feeds identified by feed correlation identifiers within received second and subsequent portions of related web feeds.

It should be understood that processing associated with expansion and collapse of a graphical user interface view, such as the hierarchical views described within FIGS. 5A and 5B below, are omitted from the process 400 for ease of description purposes. However, it is understood that such processing may form a portion of the process 400 or other processing without departure from the scope of the present subject matter.

FIG. 5A and FIG. 5B illustrate an example of an implementation of a graphical user interface pane 500 that may be used to implement the related web feed correlation with dynamic content access described herein. FIG. 5A and FIG. 5B provide graphical user interface examples for presentation of feed content and portions of related content from related feeds in response to dynamic queries for the portions of related content from the related feeds. It is understood that many other variations and possibilities exist for presentation of feed content and portions of related content from related feeds in response to dynamic queries for the portions of related content from the related feeds and all are considered within the scope of the present subject matter.

FIG. 5A and FIG. 5B will be described in association with example web feed pseudo code to provide additional detail associated with certain aspects of the present subject matter. A specific example utilized within FIG. 5A and FIG. 5B, and the example web feed pseudo code, includes test plans and related test cases. The test plans and the related test cases are each provided and accessible via a different and distinct web feed.

The test plans and the related test cases example described herein utilize related information sets accessed via two related feeds for ease of illustration purposes. However, it is understood that the present subject also applies to more than two related information sets and related feeds, and that such an implementation is within the scope of the present subject matter. Further, a person of skill in the art will be able to implement such processing based upon the description herein. It is additionally understood that the use of test plans and test cases is for description purposes and that other related types of resources or feeds may be processed in association with the present subject matter as described herein. For example, other types of resources and feeds that may utilize the present subject matter include photos, blogs, calendars, wilds, and other resources or content types.

Within the present example, test plans “use” test cases to fulfill the requirements of the respective test plans. As such, a syntax tag pair <uses> and </uses> represent the relationship between a given test plan and any test cases that the test plan uses. Similarly, test cases are “used by” test plans and a syntax tag pair <usedBy> and </usedBy> represent the relationship between a given test case and any test plans that use the test case. The test cases may be considered granular implementations of the individual tests to be executed in association with a given test plan. For purposes of the present example, a one-to-one relationship exists between a test plan and the related granular test case. However, a one-to-many, many-to-many, or other relationship may be used as appropriate for a given implementation and related subject matter of feeds or resources.

In response to detection of a request for a feed that includes test plans, a client device, such as the client computing device 102, may request the feed associated with the test plans from a feed server, such as one of the feed server_1106 through the feed server_N 108. The request may include a hypertext transfer protocol (HTTP) “GET” request, such as the following pseudo code example.

GET/feeds/testplans HTTP/1.0

In response to receipt of the HTTP GET request, the respective feed server may return the requested test plan feed. The following example test plan feed pseudo code includes several test plans, that each reference one test case for ease of description. However, it is understood that multiple test cases (e.g., related content elements from a related web feed) may be associated with a test plan without departure from the scope of the present subject matter. Further, ellipsis dots are utilized to generically illustrate a portion of each HTTP path to referenced test cases.

```
<?xml version=“1.0” encoding=“UTF-8”?>
<feed xmlns=“http://www.w3.org/2005/Atom”>
<entry>
  <title>Test Plan A</title>
  <id>A</id>
  <content type=“application/xml”>
    <testplan>
      <author>Bob</author>
      <uses>
        http:// . . . /testcase/B
      </uses>
    </testplan>
  </content>
</entry>
<entry>
  <title>Test Plan B</title>
  <id>B</id>
  <content type=“application/xml”>
    <testplan>
      <author>Bob</author>
      <uses>
        http:// . . . /testcase/C
      </uses>
    </testplan>
  </content>
</entry>
<entry>
  <title>Test Plan C</title>
  <id>C</id>
  <content type=“application/xml”>
    <testplan>
      <author>Bob</author>
      <uses>
        http:// . . . /testcase/D
      </uses>
    </testplan>
  </content>
</entry>
<entry>
  <title>Test Plan D</title>
  <id>D</id>
  <content type=“application/xml”>
    <testplan>
      <author>Bob</author>
      <uses>
        http:// .. . /testcase/D
      </uses>
    </testplan>
  </content>
</entry>
</feed>
```

As can be seen from the example test plan feed pseudo code, several test plans are defined that each “use” one test case. Further, all test plans are created by a single person, “Bob,” within the present example, and associated with the single feed shown above. The test plans are titled, “Test Plan A,” “Test Plan B,” “Test Plan C,” and “Test Plan D.” Each of the Test Plan A through the Test Plan D “uses” a single test case, referenced as “testcase/B,” “testcase/C,” “testcase/D,” and “testcase/D,” respectively.

With reference to FIG. 5A, the graphical user interface pane 500 includes a hierarchical list view of elements associated with the received test plan feed. A Test Plan A element 502, a Test Plan B element 504, a Test Plan C element 506, and a Test Plan D element 508 each respectively represent the test plans identified within the test plan feed, as shown and described above. Each of the Test Plan elements 502 through 508 is associated with a list expansion icon 510, 512, 514, and 516, respectively. Each of the list expansion icons 510 through 516 are represented as a plus (e.g., “+”) symbol to illustrate to a user that more content is available in association with each of the Test Plan elements 502 through 508, and represent selectable user interface elements for purposes of the present description. As shown above within the example pseudo code for the test plan feed, each of the Test Plan A through the Test Plan D “uses” a single test case. As such, a server, such as one of the feed server_1106 through the feed server_N 108, may be dynamically queried for the respective portion of an associated test case feed referenced by the “uses” syntax tag pair (e.g., <uses> and </uses>) for each of the Test Plan A through the Test Plan D in response to detection of a user selection of the associated selectable user interface element.

For purposes of the present example, it is assumed that a user selects the list expansion icon 510 next to the Test Plan A element 502, such as via a mouse or keyboard associated with the input device 204. In response to detecting the selection of the selectable list expansion icon 510, the client computing device 102 requests the feed of test cases used by Test Plan A. Within the example pseudo code above, the Test Plan A “uses” a test case referenced as “testcase/B.” As such, the client computing device 102 issues another HTTP GET request to dynamically query the appropriate feed server for the portion of the test case feed that is related to the Test Plan A.

The following pseudo code example illustrates one possible implementation for the dynamic query for a portion of related content from a related feed, which in this example is a “testcases” feed.

GET/feeds/testcases?xpathQuery=//feed/entry/content/testcase/usedBy=“A”

As can be seen from the pseudo code example of the dynamic query, the dynamic query identifies Test Plan A via the “usedBy” feed correlation identifier at the end of the dynamic query. This instructs the respective feed server to parse the identified feed, in this case the “testcases” feed, for any feed content elements identified within the testcases feed via a “usedBy” syntax tag pair with feed correlation identifier names that match the dynamic query (e.g., “A”).

In response to receipt of the dynamic query, the respective feed server interprets the xPath from the request, parses the testcases feed for individual related content elements, and returns a feed of test cases that are used by (e.g., related to) Test Plan A. In this example there is only one such test case. However, it is understood that multiple elements may be related and returned.

The following pseudo code example shows a testcases feed that includes only test cases (one in the present example) related to Test Plan A and that may be returned in response to the dynamic query described above.

```
<?xml version=“1.0” encoding=“UTF-8”?>
<feed xmlns=“http://www.w3.org/2005/Atom”>
<entry>
  <title>Test Case B</title>
  <id>B</id>
  <content type=“application/xml”>
    <testcase>
      <author>Sue</author>
      <usedBy>
        http://..../testplan/A
      </usedBy>
    </testcase>
  </content>
</entry>
```

As can be seen from this example pseudo code, the returned testcases feed includes one element titled Test Case B that represents a portion of the entire testcases feed that is related to the Test Plan A for which the dynamic query was issued. The pseudo code includes the “usedBy” feed correlation identifier syntax tag pair (e.g., <usedBy> and </usedBy>) that indicates that Test Case B is used by Test Plan A.

FIG. 5B illustrates updates to the graphical user interface pane 500 in response to the dynamic query and receipt of the related testcases. As can be seen from FIG. 5B, the hierarchical list view is expanded relative to the list item for Test Plan A in response to detection of the selection of the list expansion icon 510 (as shown in FIG. 5A) and the dynamic query for related feed content for the Test Plan A. A list collapse icon 518 replaces the list expansion icon 510 and illustrates that the list item Test Plan A element 502 has been expanded via selection of the list expansion icon 510.

A “Uses” list element 520 identifies a Test Case B element 522 that was received in response to the dynamic query and populated via the pseudo code described above. Further, though of lesser import to the present subject matter, it is understood that the user may select the list collapse icon 518 to return the displayed hierarchical list view to the state shown within FIG. 5A, or may select other of the list expansion icons 512 through 516 to initiate other dynamic queries for other portions of the testcases feed.

As such, FIGS. 5A and 5B illustrate a hierarchical list view rendering implementation of related feed content in response to dynamic queries for related content in related feeds. Portions of related feed content may be dynamically retrieved in response to detection of user selection of selectable list expansion icons. It should be noted, however, that the present hierarchical list view is illustrated and described for ease of illustration purposes and that many other possibilities exist for display and dynamic query of related feed content. For example, star display pattern views, ring display pattern views, or other views may be utilized to implement the present subject matter. Further, the respective display view chosen for a given implementation may be guided by the actual relationship between the related feeds and related feed content elements.

As described above in association with FIG. 1 through FIG. 5B, the example systems and processes provide related web feed correlation with dynamic content access. Many other variations and additional activities associated with related web feed correlation with dynamic content access are possible and all are considered within the scope of the present subject matter.

Those skilled in the art will recognize, upon consideration of the above teachings, that certain of the above examples are based upon use of a programmed processor, such as the CPU 200. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
determining, via a computer client device, that at least one element of received first feed content of a first feed comprises a first feed correlation identifier that identifies a portion of a second feed associated with the at least one element of the received first feed content;
displaying the received first feed content with a first selectable user interface element associated with the at least one element of the received first feed content determined to comprise the first feed correlation identifier;
detecting a selection of the first selectable user interface element; and
querying, in response to detecting the selection of the first selectable user interface element, a feed server for the portion of the second feed identified by the first feed correlation identifier.

2. The method of claim 1, further comprising:
receiving from the feed server, in response to querying the feed server for the portion of the second feed identified by the first feed correlation identifier, a portion of second feed content associated with the portion of the second feed identified by the first feed correlation identifier; and
displaying the portion of the second feed content in association with the first feed content.

3. The method of claim 2, further comprising:
determining that at least one element of the received portion of the second feed content comprises a second feed correlation identifier that identifies a portion of a third feed associated with the at least one element of the received portion of the second feed content; and
displaying the received portion of the second feed content with a second selectable user interface element associated with the at least one element of the portion of the second feed content determined to comprise the second feed correlation identifier.

4. The method of claim 3, further comprising:
detecting a selection of the second selectable user interface element; and
querying, in response to detecting the selection of the second selectable user interface element, the feed server for the portion of the third feed identified by the second feed correlation identifier.

5. The method of claim 4, further comprising:
receiving from the feed server, in response to querying the feed server for the portion of the third feed identified by the second feed correlation identifier, a portion of third feed content associated with the portion of the third feed identified by the second feed correlation identifier; and
displaying the portion of the third feed content in association with the portion of the second feed content.

6. The method of claim 1, where displaying the received first feed content with the first selectable user interface element comprises:
displaying a hierarchical list view of the at least one element of the received first feed content; and
displaying a selectable list expansion icon in association with the at least one element of the received first feed content determined to comprise the first feed correlation identifier within the hierarchical list view.

7. The method of claim 6, further comprising:
receiving from the feed server, in response to querying the feed server for the portion of the second feed identified by the first feed correlation identifier, a portion of second feed content associated with the portion of the second feed identified by the first feed correlation identifier;
expanding the hierarchical list view of the at least one element of the received first feed content;
displaying a hierarchical expansion list view of the portion of the second feed content in association with the at least one element of the received first feed content within the hierarchical list view; and
displaying a selectable list collapse icon in association with the at least one element of the received first feed content determined to comprise the first feed correlation identifier within the hierarchical list view.

8. A system, comprising:
a display;
an input device; and
a processor programmed to:
determine that at least one element of received first feed content of a first feed comprises a first feed correlation identifier that identifies a portion of a second feed associated with the at least one element of the received first feed content;
display the received first feed content with a first selectable user interface element associated with the at least one element of the received first feed content determined to comprise the first feed correlation identifier via the display;
detect a selection of the first selectable user interface element via the input device; and
query, in response to detecting the selection of the first selectable user interface element via the input device, a feed server for the portion of the second feed identified by the first feed correlation identifier.

9. The system of claim 8, where the processor is further programmed to:
receive from the feed server, in response to querying the feed server for the portion of the second feed identified by the first feed correlation identifier, a portion of second feed content associated with the portion of the second feed identified by the first feed correlation identifier; and
display the portion of the second feed content in association with the first feed content via the display.

10. The system of claim 9, where the processor is further programmed to:
determine that at least one element of the received portion of the second feed content comprises a second feed correlation identifier that identifies a portion of a third feed associated with the at least one element of the received portion of the second feed content; and
display the received portion of the second feed content with a second selectable user interface element associated with the at least one element of the portion of the second feed content determined to comprise the second feed correlation identifier via the display.

11. The system of claim 10, where the processor is further programmed to:
detect a selection of the second selectable user interface element via the input device; and
query, in response to detecting the selection of the second selectable user interface element via the input device, the feed server for the portion of the third feed identified by the second feed correlation identifier.

12. The system of claim 8, where, in being programmed to display the received first feed content with the first selectable user interface element, the processor is programmed to:
display a hierarchical list view of the at least one element of the received first feed content via the display; and
display a selectable list expansion icon in association with the at least one element of the received first feed content determined to comprise the first feed correlation identifier within the hierarchical list view via the display.

13. The system of claim 12, where the processor is further programmed to:
receive from the feed server, in response to querying the feed server for the portion of the second feed identified by the first feed correlation identifier, a portion of second feed content associated with the portion of the second feed identified by the first feed correlation identifier;
expand the hierarchical list view of the at least one element of the received first feed content;
display a hierarchical expansion list view of the portion of the second feed content in association with the at least one element of the received first feed content within the hierarchical list view via the display; and
display a selectable list collapse icon in association with the at least one element of the received first feed content determined to comprise the first feed correlation identifier within the hierarchical list view via the display.

14. A computer program product comprising a computer readable storage medium including computer readable program code, where the computer readable program code when executed on a computer causes the computer to:
determine, via a computer client device, that at least one element of received first feed content of a first feed comprises a first feed correlation identifier that identifies a portion of a second feed associated with the at least one element of the received first feed content;
display the received first feed content with a first selectable user interface element associated with the at least one element of the received first feed content determined to comprise the first feed correlation identifier;
detect a selection of the first selectable user interface element; and
query, in response to detecting the selection of the first selectable user interface element, a feed server for the portion of the second feed identified by the first feed correlation identifier.

15. The computer program product of claim 14, where the computer readable program code when executed on the computer further causes the computer to:
receive from the feed server, in response to querying the feed server for the portion of the second feed identified by the first feed correlation identifier, a portion of second feed content associated with the portion of the second feed identified by the first feed correlation identifier; and
display the portion of the second feed content in association with the first feed content.

16. The computer program product of claim 15, where the computer readable program code when executed on the computer further causes the computer to:
determine that at least one element of the received portion of the second feed content comprises a second feed correlation identifier that identifies a portion of a third feed associated with the at least one element of the received portion of the second feed content; and
display the received portion of the second feed content with a second selectable user interface element associated with the at least one element of the portion of the second feed content determined to comprise the second feed correlation identifier.

17. The computer program product of claim 16, where the computer readable program code when executed on the computer further causes the computer to:
detect a selection of the second selectable user interface element; and
query, in response to detecting the selection of the second selectable user interface element, the feed server for the portion of the third feed identified by the second feed correlation identifier.

18. The computer program product of claim 17, where the computer readable program code when executed on the computer further causes the computer to:
receive from the feed server, in response to querying the feed server for the portion of the third feed identified by the second feed correlation identifier, a portion of third feed content associated with the portion of the third feed identified by the second feed correlation identifier; and
display the portion of the third feed content in association with the portion of the second feed content.

19. The computer program product of claim 14, where, in causing the computer to display the received first feed content with the first selectable user interface element, the computer readable program code when executed on the computer causes the computer to:
display a hierarchical list view of the at least one element of the received first feed content; and
display a selectable list expansion icon in association with the at least one element of the received first feed content determined to comprise the first feed correlation identifier within the hierarchical list view.

20. The computer program product of claim 19, where the computer readable program code when executed on the computer further causes the computer to:
receive from the feed server, in response to querying the feed server for the portion of the second feed identified by the first feed correlation identifier, a portion of second feed content associated with the portion of the second feed identified by the first feed correlation identifier;
expand the hierarchical list view of the at least one element of the received first feed content;
display a hierarchical expansion list view of the portion of the second feed content in association with the at least one element of the received first feed content within the hierarchical list view; and
display a selectable list collapse icon in association with the at least one element of the received first feed content determined to comprise the first feed correlation identifier within the hierarchical list view.
